(19) United States
(12) Patent Application Publication
(10) Pub. No.: US 2007/0200385 A1
(43) Pub. Date: Aug. 30, 2007

(54) OPENABLE VEHICLE ROOF HAVING A FABRIC COVER

(75) Inventor: Matthias Roesler, Stuttgart (DE)

Correspondence Address: BROOKS KUSHMAN P.C., 1000 TOWN CENTER, TWENTY-SECOND FLOOR, SOUTHFIELD, MI, 48075, US

(73) Assignee: Magna Car Top Systems GmbH, Bietigheim-Bissingen (DE)

(21) Appl. No.: 11/469,126

(22) Filed: Aug. 31, 2006

(30) Foreign Application Priority Data
Aug. 31, 2005 (DE) 10 2005 041 541.5

(51) Int. Cl. B60J 7/00

(52) U.S. Cl. 296/107.09

(57) ABSTRACT

An openable vehicle roof includes a fabric cover. The fabric cover is supported by a folding top linkage to be adjustable between a closed position and a stored position. A seal support for the vehicle roof has a sealing element which in the side region contacts the side window when the vehicle roof is closed. The seal support is designed as an independent, adjustably mounted support part which during the transition motion between the closed and the stored position undergoes a relative motion with respect to the folding top kinematic system. The fabric cover is also attached to the seal support.

### CROSS-REFERENCE TO RELATED APPLICATIONS

This application claims foreign priority benefits under 35 U.S.C. §119(a)-(d) to DE 10 2005 041 541.5, filed Aug. 31, 2005, which is hereby incorporated by reference in its entirety.

### BACKGROUND OF THE INVENTION

1. Field of the Invention

The present invention relates to a motor vehicle roof having a fabric cover supported by a folding top linkage in which the roof is movable between a closed position in which the fabric cover covers the vehicle interior and a rear stored position.

2. Background Art

Soft-top vehicle roofs include a fabric cover supported by a folding top linkage. Using a kinematic adjustment system, the folding top linkage is adjustable between a closed position in which the roof covers the vehicle interior and a rear stored position in which the roof is stowed such that the vehicle interior is exposed. The folding top linkage includes guide rods and hoops coupled to one another or to the vehicle body. When the roof is closed, a lateral linkage part of the folding top linkage overlaps a side window of the vehicle. A watertight seal on the side window is provided by a sealing element on the lateral linkage part. When the roof is closed, the lateral linkage part is situated in a longitudinal vertical plane of the vehicle, and for storage the roof is simultaneously swivelled backward about a body-side swivel axis and in the direction of the vehicle centerline.

DE 196 13 356 A1 (corresponding to U.S. Pat. No. 6,139,087), for example, discloses such a vehicle roof. The kinematic system of this roof includes a first body-mounted four-bar kinematic linkage having two main guide rods. One of the guide rods forms the seal support. A second articulated kinematic linkage is situated on a lateral frame part and establishes a connection between the two guide rods of the first four-bar kinematic linkage. The roof includes a front roof cap which directly contacts the windshield frame when the roof is closed and which is retained and moved by the second kinematic linkage. When the roof is stored, both kinematic linkages are swivelled backward, and the front roof cap has the same orientation in the storage compartment as in the closed state.

It is disadvantageous that the width of the roof cap is slightly smaller than the rear sections of the roof adjacent to the rear of the vehicle, so that when the roof is stored a gap is present between the sides of the roof cap and the adjacent storage compartment walls. For esthetic reasons, the gap must be covered by means of additional measures such as separate flaps or strip-shaped lids. This entails significant additional effort.

### SUMMARY OF THE INVENTION

An object of the present invention is to provide by simple means an openable soft-top vehicle roof which has an esthetic appearance even when in the stored position. The aim is to achieve this in particular without additional lateral flaps or the like.

In carrying out the above object and other objects, the present invention provides an openable roof for a vehicle. The roof includes a fabric cover, a folding top linkage supporting the fabric cover, a folding top kinematic system which acts on the folding top linkage to move the fabric cover between a closed position and an opened position, and seal support attached to the fabric cover and adjustably mountable to a support part such that the seal support undergoes a relative motion with respect to the folding top kinematic system during a transition motion of the fabric cover between the closed and stored positions so that the seal support is situated in a longitudinal vertical plane when the fabric cover is in the closed position and has a component extending transversely to the longitudinal vertical plane when the fabric cover is in the opened position.

In carrying out the above object and other objects, the present invention provides a motor vehicle having a side body and a side window which form part of a vehicle interior. The vehicle including a roof having a fabric cover supported by a folding top linkage. A folding top kinematic system is mounted to the side body and coupled to the folding top linkage to act on the folding top linkage to move the roof between a closed position in which the fabric cover covers the vehicle interior and a rear stored position in which the fabric cover is stowed in a rear compartment of the vehicle such that the vehicle interior is exposed. A seal support includes a sealing element which contacts the side window when the roof is in the closed position. The seal support is attached to the fabric cover and adjustably mounted to the side body such that the seal support undergoes a relative motion with respect to the folding top kinematic system during a transition motion of the roof between the closed and stored positions so that the seal support is situated in a longitudinal vertical plane when the roof is in the closed position and has a component extending transversely to the longitudinal vertical plane when the roof is in the opened position.

In the openable vehicle roof according to the present invention, the seal support, which is situated in the side region when the roof is closed and supports a seal which contacts the closed side window, is designed as an independent, movable support part to which the fabric cover is attached. The seal support thus provides a two-fold function: on the one hand, the sealing element is attached to the seal support; and on the other hand, the fabric cover is also attached to the seal support. Because the seal support forms a component that is independent from the folding top linkage or the folding top kinematic system and is mounted so as be adjustable, the cover material is also moved during an adjustment motion of the seal support.

Due to the relative motion of the seal support with respect to the folding top kinematic system during the transition from the closed to the stored position, the storage of the fabric cover in the stored position may be influenced and controlled in a targeted manner. This is achieved in particular by virtue of the fact that in the stored position a portion of the fabric cover overlaps the lateral regions in the storage compartment, thereby covering gaps between the stored side regions of the roof and providing an esthetic appearance without additional measures such as separate flaps or the like. In the embodiments from the prior art this is not possible without such flaps, because without additional control the fabric cover does not extend past the side regions in the storage compartment.

According to an embodiment of the present invention, the seal support is mounted directly on the vehicle body. In particular, the seal support is pivotably connected to the vehicle body by means of an articulated joint, and during storage advantageously undergoes a swivel motion in the direction of the center axis of the vehicle. In this motion from a position associated with the closed position of the roof, in which the seal support is situated in a longitudinal vertical plane, to a position having a component transverse to the longitudinal axis of the vehicle, a side section of the fabric cover extends over the laterally open gaps in the storage compartment. This is advantageously supported by the fact that the seal support in the stored position, as seen in the longitudinal direction of the vehicle, comes to rest in front of the front roof section (which advantageously is formed by a roof cap), i.e., in the stored position between the front roof section and the vehicle interior.

As an alternative to a body-side attachment of the seal support, a connection may also be made to a linkage part for the folding top linkage, the seal support undergoing a relative motion with respect to this additional linkage part during storage of the roof.

In both cases, i.e., for a body-side attachment of the seal support as well as an attachment to a linkage part of the roof, the seal support advantageously undergoes a mechanically controlled motion which may be achieved, for example, by means of an additional coupling to the folding top linkage or the folding top kinematic system.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a perspective view of a convertible vehicle having a vehicle roof designed as a soft-top, illustrated in the closed position;

FIG. 2 illustrates the convertible vehicle with the soft-top in a partially opened position during the transitional motion from the closed to the stored position;

FIG. 3 illustrates the convertible vehicle with the soft-top in a further progression of the open position, shortly before reaching the stored position; and

FIG. 4 illustrates the convertible vehicle with the soft-top in the stored position, in a top view.

### DETAILED DESCRIPTION OF THE PREFERRED EMBODIMENT(S)

Identical components are provided with the same reference numerals in the figures.

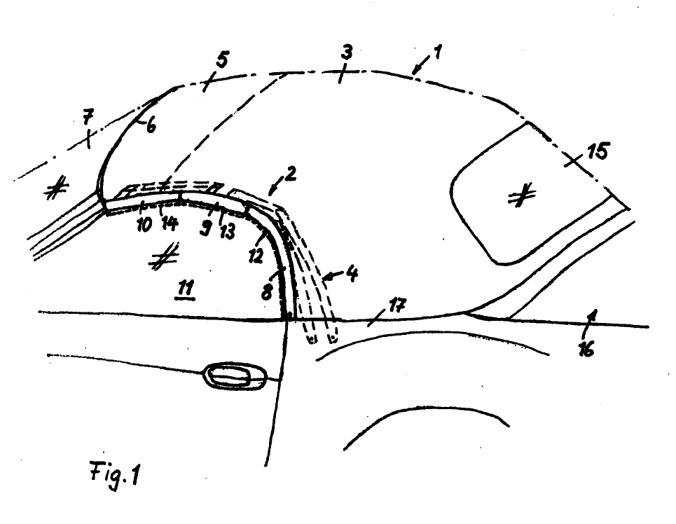

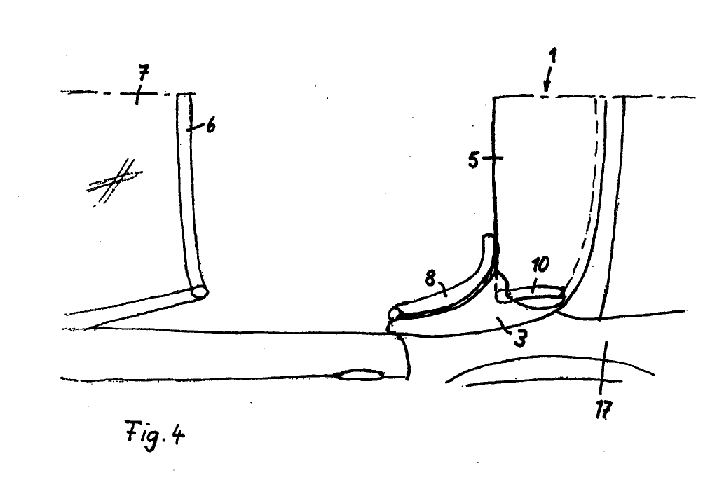

The convertible vehicle illustrated in FIG. 1 includes a soft-top roof 1. Roof 1 has a fabric cover 3. A folding top linkage 2 supports fabric cover 3. Roof 1 may be moved between a closed position (FIG. 1) covering the vehicle interior and an open position (FIG. 4) in which the roof is stored in a rear storage compartment 16 of the vehicle. For changing or moving roof 1 between the closed and open positions, a folding top kinematic system 4 acts on folding top linkage 2. Optionally, folding top kinematic system 4 forms a component of folding top linkage 2. Folding top kinematic system 4 includes two guide rods, pivotably mounted on each vehicle body side 17, which form a four-bar kinematic linkage.

A roof cap 5 located in the front is integrated into roof 1. Roof cap 5 is designed as a fixed roof part which is covered by fabric cover 3. In the closed position, the front edge of roof cap 5 directly abuts a windshield frame 6. Windshield frame 6 supports a windshield 7. A rear window 15 is situated in the rear area of roof 1.

In the closed position of roof 1, in the side region of the roof a side window 11 is enclosed by a seal support 8 as well as two additional roof side parts 9 and 10. Seal support 8 and roof side parts 9 and 10 are situated in a common, continuous line corresponding to the side window contour. Seen in the longitudinal direction, seal support 8 and roof side parts 9 and 10 extend between windshield frame 6 and the rear vehicle body-side attachment of seal support 8. Seal support 8 is pivotably coupled to vehicle body 17, independent from folding top kinematic system 4. Also possible, however, is an attachment of seal support 8 to folding top kinematic system 4 with the capability of relative motion with respect to the folding top kinematic system. Both seal support 8 and roof side parts 9 and 10 which are aligned with the seal support are components of folding top linkage 2. Seal support 8 located in the rear undergoes a relative motion during the transition of roof 1 between the closed and the stored position.

For a tight seal between side window 11 and roof 1, sealing elements 12, 13, and 14 are respectively provided on seal support 8 and roof side parts 9 and 10. Folding top kinematic system 4 is advantageously connected to center roof part 9, which in turn is coupled to front roof side part 10 via a further multiple-joint kinematic system. Seal support 8 located in the rear may likewise be coupled to folding top kinematic system 4, or to a roof side part 9 or 10 located farther to the front, in order to achieve a kinematic mechanically controlled motion during the transition between the closed and the stored position.

It is noted that like components are preferably on each side of the vehicle. For instance, two folding top linkages 2 are on respective sides of the vehicle, two folding top kinematic systems 4 are on respective sides of the vehicle, two seal supports 8 are on respective sides of the vehicle, the vehicle includes two side windows 11, etc.

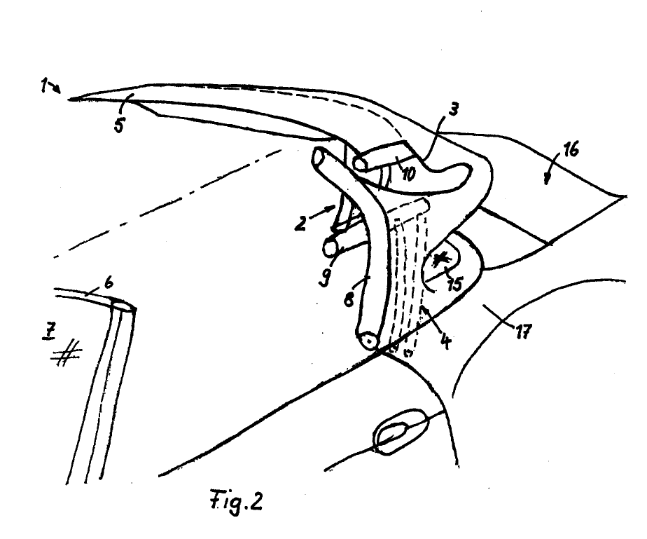

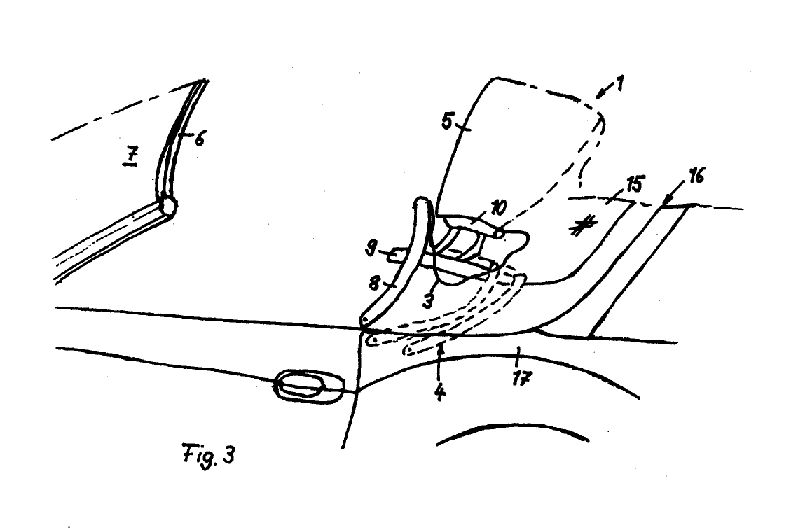

Fabric cover 3 is fixedly connected to seal support 8 and to roof cap 5, as seen in FIGS. 2 through 4. As a result of the relative motion between seal support 8 and roof cap 5, the section of material of fabric cover 3 between the seal support and the roof cap is likewise subjected to a relative motion. In the storage motion of roof 1, seal support 8 is stowed about its body-side articulated joint in the direction of the rear of the vehicle and in the direction of the center of the vehicle, thereby shortening the relative distance between seal support 8 and roof cap 5, causing the fabric cover material section therebetween to become slack. In the stored or open position of roof 1 shown in FIG. 4, curved seal support 8 is stored laterally, i.e., toward the center of the vehicle. That is, seal support 8 has a component transverse to the longitudinal axis of the vehicle.

Because the width of roof cap 5 is slightly smaller than the back, rear region of roof 1, in particular in the region of seal support 8, as seen in the transverse direction, there is a gap between the attachment of seal support 8 to the vehicle body and the lateral sections of roof cap 5. However, this gap is covered by the section of fabric cover 3 extending between seal support 8 and the lateral material attachment to the vehicle shell, i.e., to the vehicle body. In this manner additional covering measures, such as flaps or the like, for covering this gap may be omitted.

### LIST OF REFERENCE NUMERALS

1 Vehicle roof
2 Folding top linkage
3 Fabric cover
4 Folding top kinematic system
5 Roof cap
6 Windshield frame
7 Windshield
8 Seal support
9 Roof side part
10 Roof side part
11 Side window
12 Sealing element
13 Sealing element
14 Sealing element
15 Rear window
16 Storage compartment
17 Vehicle body

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. An openable roof for a vehicle, the roof comprising:
a fabric cover;
a folding top linkage supporting the fabric cover;
a folding top kinematic system which acts on the folding top linkage to move the fabric cover between a closed position and an opened position; and
a seal support attached to the fabric cover and adjustably mountable to a support part such that the seal support undergoes a relative motion with respect to the folding top kinematic system during a transition motion of the fabric cover between the closed and stored positions so that the seal support is situated in a longitudinal vertical plane when the fabric cover is in the closed position and has a component extending transversely to the longitudinal vertical plane when the fabric cover is in the opened position.

2. The roof of claim 1 wherein:
the seal support swivels from a position in a side region of the fabric cover to a position toward the fabric cover during the transition of the fabric cover from the closed position to the stored position.

3. The roof of claim 1 wherein:
the support part is a vehicle body, and the seal support is adjustably mounted to the vehicle body in an articulated manner.

4. The roof of claim 1 wherein:
the seal support is coupled to the folding top kinematic system in an articulated manner.

5. The roof of claim 1 wherein:
the folding top kinematic system is coupled to the seal support and moves the seal support such that the seal support undergoes a mechanical controlled motion during fabric cover storing and closing motions of the folding top kinematic system.

6. The roof of claim 1 wherein:
the seal support is situated in the rear region of the fabric cover.

7. The roof of claim 1 further comprising:
a front roof cap connected to the fabric cover such that the front roof cap is situated adjacent to a windshield frame of a vehicle when the roof is connected to the vehicle and the fabric cover is in the closed position.

8. The roof of claim 7 wherein:
the width of the front roof cap is smaller than the width of a rear portion of the fabric cover in the transverse direction.

9. The roof of claim 7 wherein:
the fabric cover is attached to the front roof cap, wherein in the stored position a section of the fabric cover overlaps a region adjacent to the support part.

10. A motor vehicle comprising:
a side body and a side window which form part of a vehicle interior;
a roof having a fabric cover supported by a folding top linkage;
a folding top kinematic system mounted to the side body and coupled to the folding top linkage to act on the folding top linkage to move the roof between a closed position in which the fabric cover covers the vehicle interior and a rear stored position in which the fabric cover is stowed in a rear compartment of the vehicle such that the vehicle interior is exposed; and
a seal support having a sealing element which contacts the side window when the roof is in the closed position, the seal support being attached to the fabric cover and adjustably mounted to the side body such that the seal support undergoes a relative motion with respect to the folding top kinematic system during a transition motion of the roof between the closed and stored positions so that the seal support is situated in a longitudinal vertical plane when the roof is in the closed position and has a component extending transversely to the longitudinal vertical plane when the roof is in the opened position.

11. The vehicle of claim 10 wherein:
the seal support swivels from a position in a side region of the roof to a position toward the center of the vehicle interior during the transition of the fabric cover from the closed position to the stored position.

12. The vehicle of claim 10 wherein:
the seal support is adjustably mounted to the body side in an articulated manner.

13. The vehicle of claim 10 wherein:
the seal support is coupled to the folding top kinematic system in an articulated manner.

14. The vehicle of claim 10 wherein:
the folding top kinematic system is coupled to the seal support and moves the seal support such that the seal support undergoes a mechanical controlled motion during roof storing and closing motions of the folding top kinematic system.

15. The vehicle of claim 10 wherein:
the seal support is situated in the rear region of the roof.

16. The vehicle of claim 10 further comprising:
a windshield frame;
wherein the roof further includes a front roof cap connected to the fabric cover such that the front roof cap is situated adjacent to the windshield frame when the roof is in the closed position.

17. The vehicle of claim 16 wherein:
the width of the front roof cap is smaller than the width of a rear portion of the fabric cover in the transverse direction.

18. The vehicle of claim 16 wherein:
the fabric cover is attached to the front roof cap, wherein in the stored position a section of the fabric cover overlaps a region adjacent to the mounting between the seal support and the body side.

19. The vehicle of claim 10 wherein:
the seal support is pivotably coupled to the side body.

20. The vehicle of claim 10 wherein:
the seal support is connected to the folding top linkage.
